(19) United States
(12) Patent Application Publication
(10) Pub. No.: US 2025/0172946 A1
(43) Pub. Date: May 29, 2025

(54) SMART SNOW REMOVAL METHOD, SNOW REMOVAL ROBOT AND SMART SNOW REMOVAL EQUIPMENT

(71) Applicant: Shenzhen Hanyang Technology Co., Ltd., Shenzhen (CN)

(72) Inventors: Yang HUANG, Shenzhen (CN); Jialai LI, Shenzhen (CN)

(73) Assignee: Shenzhen Hanyang Technology Co., Ltd., Shenzhen (CN)

(21) Appl. No.: 19/026,154

(22) Filed: Jan. 16, 2025

Related U.S. Application Data
(63) Continuation of application No. PCT/CN2022/143005, filed on Dec. 28, 2022.

(51) Int. Cl. G05D 1/648; E01H 5/04; E01H 5/08; G05D 1/248; G05D 1/633; G05D 105/00

(52) U.S. Cl. CPC G05D 1/6482; E01H 5/045; G05D 1/248; G05D 1/633; E01H 5/08; G05D 2105/12

(57) ABSTRACT

Disclosed is a smart snow removal method, applied to a snow removal robot. The method includes: obtaining, through global positioning system real-time kinematic (GPS-RTK) positioning technology, a latitude and longitude coordinates of a target snow throwing area and a target snow removal area, to generate a snow removal map; rasterizing the snow removal map; converting the snow removal map into a potential field: starting from a grid located in the target snow throwing area, and assigning, through a breadth-first search (BFS) algorithm, a potential energy value to the grid located in the target snow removal area in an outward diffusion manner; wherein the potential energy value increases with an increase in a number of diffusion layers; and controlling the snow removal robot to travel on an uncleaned grid with a highest current potential energy value one by one, and performing the snow removal operation on an arrived grid.

### CROSS-REFERENCE TO RELATED APPLICATIONS

The present application is a continuation application of International Application No. PCT/CN2022/143005, filed on Dec. 28, 2022, the content of which is incorporated herein by reference in its entirety.

### TECHNICAL FIELD

The present application relates to the technical field of snow removal equipment, particularly to a smart snow removal method, a snow removal robot, and a smart snow removal equipment.

### BACKGROUND

The current automatic snowplows commonly employ ultra-wide band (UWB) tag wireless carrier communication for positioning, which is unable to drive the snowplow to clean multiple areas in one go, resulting in low snow removal efficiency.

### SUMMARY

The main objective of the present application is to propose a smart snow removal method, aiming to solve the technical problem of the aforementioned automatic snowplows being unable to clean multiple areas in one go and having low snow removal efficiency.

To achieve the aforementioned objectives, the present application proposes a smart snow removal method, applied to a snow removal robot, wherein the snow removal robot includes:
a traveling component, configured to travel along a planned path;
a snow feeding component, provided at the traveling component, and configured to collect snow during a snow removal operation; and
a snow throwing component, provided at the traveling component, connected to the snow feeding component, and configured to throw the snow collected by the snow feeding component to a preset area during the snow removal operation;
the smart snow removal method includes:
obtaining, through global positioning system real-time kinematic (GPS-RTK) positioning technology, a latitude and longitude coordinates of a target snow throwing area and a target snow removal area, to generate a snow removal map;
rasterizing the snow removal map;
converting the snow removal map into a potential field: starting from a grid located in the target snow throwing area, and assigning, through a breadth-first search (BFS) algorithm, a potential energy value to the grid located in the target snow removal area in an outward diffusion manner; wherein the potential energy value increases with an increase in a number of diffusion layers; and
controlling the snow removal robot to travel on an uncleaned grid with a highest current potential energy value one by one, and performing the snow removal operation on an arrived grid.

Furthering, after the rasterizing the snow removal map, the method includes:
determining, through an angle method, whether each grid is located in the target snow removal area: taking a connection line between a center point of each grid and each vertex of the target snow removal area as a first auxiliary line, and determining whether a sum of angles between all the first auxiliary lines corresponding to the center point is 360°; in response to that the sum of the angles between all the first auxiliary lines corresponding to the center point is 360°, determining that a corresponding grid is located in the target snow removal area;
setting the grid in the target snow removal area as a snow removal grid; and
setting the grid in the target snow throwing area as a snow throwing grid;
the starting from the grid located in the target snow throwing area, and assigning, through the BFS algorithm, the potential energy value to the grid located in the target snow removal area in the outward diffusion manner includes:
starting from the snow throwing grid, and assigning, through the BFS algorithm, the potential energy value to the snow removal grid in the outward diffusion manner.

Furthering, the obtaining, through GPS-RTK positioning technology, the latitude and longitude coordinates of the target snow throwing area and the target snow removal area, to generate the snow removal map includes:
obtaining, through GPS-RTK positioning technology, the latitude and longitude coordinates of the target snow throwing area, the target snow removal area and a static obstacle area, to generate the snow removal map;
after the rasterizing the snow removal map, the method includes:
determining, through the angle method, whether each grid overlaps with the static obstacle area: taking the connection line between each grid vertex of every grid and each vertex of the static obstacle area as a second auxiliary line, and determining whether the sum of angles between all the second auxiliary lines corresponding to each grid vertex is 360°; in response to that the sum of angles between all the second auxiliary lines corresponding to each grid vertex is 360°, determining that the corresponding grid overlaps with the static obstacle area; and
setting the grid overlapping with the static obstacle area as a static obstacle grid;
before the starting from the snow throwing grid, and assigning, through the BFS algorithm, the potential energy value to the snow removal grid in the outward diffusion manner, the method includes:
determining whether there is the static obstacle grid in the snow removal grid; in response to that there is the static obstacle grid in the snow removal grid, removing the static obstacle grid from the snow removal grid.

Furthering, the taking the connection line between the center point of each grid and each vertex of the target snow removal area as the first auxiliary line, and determining whether the sum of the angles between all the first auxiliary lines corresponding to the center point is 360° includes:
determining whether the center point satisfies the following formula:

$${\sum }_{i ∈ P , j = i + 1 ( next )} {sin}^{- 1} ( \frac{\begin{matrix}\to \\ {OP}_{i}\end{matrix} \times \begin{matrix}\to \\ {OP}_{j}\end{matrix}}{\vert \begin{matrix}\to \\ {OP}_{i}\end{matrix} \vert * \vert \begin{matrix}\to \\ {OP}_{j}\end{matrix} \vert} ) = 2 k π ( k ϵ Z )$$

wherein O represents a coordinate of the center point, Pᵢ and Pⱼ represent coordinates of two adjacent vertices in the target snow removal area, a superscripts of \vec{OPᵢ} and \vec{OPⱼ} represent vector symbols, and Z represents a set of integers;
in response to that the center point satisfies the above formula, determining the sum of the angles between all the first auxiliary lines corresponding to the center point is 360°.

Furthering, the taking the connection between each grid vertex of every grid to each vertex of the static obstacle area as the second auxiliary line, and determining whether the sum of the angles between all the second auxiliary lines corresponding to each grid vertex is 360° includes:
determining whether the grid vertex satisfy the following formula:

$${\sum }_{i ∈ P , j = i + 1 ( next )} {sin}^{- 1} ( \frac{\begin{matrix}\to \\ {DP}_{i}\end{matrix} \times \begin{matrix}\to \\ {DP}_{j}\end{matrix}}{\vert \begin{matrix}\to \\ {DP}_{i}\end{matrix} \vert * \vert \begin{matrix}\to \\ {DP}_{j}\end{matrix} \vert} ) = 2 k π ( k ϵ Z )$$

wherein D represents the coordinates of the grid vertices, Pᵢ and Pⱼ represent the coordinates of two adjacent vertices in the target snow removal area, the superscripts of \vec{DPᵢ} and \vec{DPⱼ} represent vector symbols, and Z represents the set of integers;
in response to that the grid vertex satisfy the above formula, determining the sum of the angles between all the second auxiliary lines corresponding to the grid vertices is 360°.

Furthering, the controlling the snow removal robot to travel on the uncleaned grid with the highest current potential energy value one by one, and performing the snow removal operation on the arrived grid includes:
in response to the snow removal robot completing the snow removal operation on the snow removal grid, searching, with the snow removal robot as a center, whether there is a first target snow removal grid with the potential energy value being greater than or equal to the potential energy value of the grid where the snow removal robot is currently located within a preset range; wherein the first target snow removal grid is in an uncleared state;
in response to an existence of the first target snow removal grid with the potential energy value being greater than or equal to the potential energy value of the grid where the snow removal robot is currently located within the preset range, controlling the snow removal robot to travel along the snow removal grid to the nearest first target snow removal grid, to perform the snow removal operation on the first target snow removal grid;
in response to an absence of the first target snow removal grid with the potential energy value being greater than or equal to the potential energy value of the grid where the snow removal robot is currently located within the preset range, searching, with the snow removal robot as the center, whether there is a second target snow removal grid with the potential energy value being less than the potential energy value of the grid where the snow removal robot is currently located within the preset range; wherein the second target snow removal grid is in the uncleared state; and
in response to the existence of the second target snow removal grid with the potential energy value being less than the potential energy value of the grid where the snow removal robot is currently located within the preset range, controlling the snow removal robot to travel along the snow removal grid to the nearest second target snow removal grid, to perform the snow removal operation on the second target snow removal grid.

Furthering, after the searching, with the snow removal robot as the center, whether there is the second target snow removal grid with the potential energy value being less than the potential energy value of the grid where the snow removal robot is currently located within the preset range, the method includes:
in response to the absence of the second target snow removal grid with potential energy value being less than the potential energy value of the grid where the snow removal robot is currently located within the preset range, searching, with the snow removal robot as the center, whether there is the snow throwing grid within the preset range;
in response to the existence of the snow throwing grid within the preset range, searching whether there is a third target snow removal grid uncleared in the snow removal map;
in response to the existence of the third target snow removal grid in the snow removal map, controlling, through a D*Lite algorithm, the snow removal robot to travel along the snow removal grid to the third target snow removal grid with the highest potential energy value, to perform the snow removal operation on the third target snow removal grid; and
in response to the snow removal robot completing the snow removal operation on the third target snow removal grid, repeating the step of searching, with the snow removal robot as the center, whether there is the first target snow removal grid with potential energy value being greater than or equal to the potential energy value of the grid where the snow removal robot is currently located within the preset range.

Furthering, the performing the snow removal operation on the arrived grid includes:
collecting snow by the snow feeding component;
determining whether there is the snow throwing grid in the preset range;
in response to the absence of the snow throwing grid in the preset range, taking the uncleared snow removal grid with the potential energy value being the lowest in the preset range as an actual snow throwing grid;
in response to the existence of the snow throwing grid in the preset range, taking the snow throwing grid as the actual snow throwing grid; and
directing a snow throwing direction of the snow throwing component toward the actual snow throwing grid.

Furthering, an uncleaned mark is set on the snow throwing grid and on the snow removal grid where the snow removal robot has not performed the snow removal operation; and a cleared mark is set on the snow removal grid where the snow removal robot has completed the snow removal operation.

Furthering, the traveling component is provided with a millimeter wave radar sensor device; and
the controlling the snow removal robot to travel along the snow removal grid to the nearest first target snow removal grid, to perform the snow removal operation on the first target snow removal grid includes:
during the snow removal robot traveling toward the nearest first target snow removal grid, performing, by the millimeter wave radar sensor device, dynamic obstacle detection on a traveling path;
in response to the millimeter wave radar sensor device detecting a dynamic obstacle in front of the snow removal robot, controlling the snow removal robot to stop traveling;
obtaining, by the millimeter wave radar sensor device, dynamic obstacle information, to mark the grid overlapping with the dynamic obstacle as a dynamic obstacle grid; and
excluding the dynamic obstacle grid from the snow removal grid, and repeating the step of searching, with the snow removal robot as the center, whether there is the first target snow removal grid with potential energy value being greater than or equal to the potential energy value of the grid where the snow removal robot is currently located within the preset range.

Furthering, the traveling component is provided with a millimeter wave radar sensor device; and
the controlling the snow removal robot to travel along the snow removal grid to the nearest second target snow removal grid, to perform the snow removal operation on the second target snow removal grid includes:
during the snow removal robot traveling toward the nearest second target snow removal grid, performing, by the millimeter wave radar sensor device, dynamic obstacle detection on the traveling path;
in response to the millimeter wave radar sensor device detecting the dynamic obstacle in front of the snow removal robot, controlling the snow removal robot to stop traveling;
obtaining, by the millimeter wave radar sensor device, the dynamic obstacle information, to mark the grid overlapping with the dynamic obstacle as the dynamic obstacle grid; and
excluding the dynamic obstacle grid from the snow removal grid, and repeating the step of searching, with the snow removal robot as the center, whether there is the second target snow removal grid with potential energy value being less than the potential energy value of the grid where the snow removal robot is currently located within the preset range.

Furthering, the directing the snow throwing direction of the snow throwing component toward the actual snow throwing grid includes:
obtaining, through GPS-RTK positioning technology, first relative position information between the grid where the snow removal robot is currently located and the actual snow throwing grid; and
adjusting, according to the first relative position information, a snow throwing angle of the snow throwing component.

Furthering, the snow throwing component includes a snow throwing drive device, a first rotary drive device, a second rotary drive device, a snow throwing cylinder and a snow throwing cylinder cover; the snow throwing cylinder is rotatably connected to the traveling component along a vertical axis, and the snow throwing cylinder cover is rotatably connected to the snow throwing cylinder along a horizontal axis; one end of the snow throwing cylinder is communicated with the snow feeding component, and the other end of the snow throwing cylinder is communicated with one end of the snow throwing cylinder cover; the snow throwing drive device is provided between one end of the snow throwing cylinder and the snow feeding component; the first rotary drive device is connected to the snow throwing cylinder through a rotary base, and the second rotating drive device is connected to the snow throwing cylinder cover; the snow throwing drive device is configured to push the snow collected by the snow feeding component into the snow throwing cylinder, and throw the snow out from the other end of the snow throwing cylinder cover; and
the obtaining, through GPS-RTK positioning technology, the first relative position information between the grid where the snow removal robot is currently located and the actual snow throwing grid includes:
obtaining, through GPS-RTK positioning technology, a first center point coordinates of the grid where the snow removal robot is currently located and a second center point coordinates of the actual snow throwing grid; taking a horizontal line between the first center point coordinates and the second center point coordinates as an adjustment reference line, and obtaining a length of the adjustment reference line;
driving, by the first rotary drive device, the snow throwing cylinder to rotate, so that a horizontal angle between the direction of the other end of the snow throwing cylinder cover on the horizontal plane and the adjustment reference line is less than a first preset angle; and
calculating a snow throwing inclination angle based on the length of the adjustment reference line, and driving, by the second rotary drive device, the snow throwing cylinder cover to rotate, so that a vertical angle between the direction of the other end of the snow throwing cylinder cover on the vertical plane and the adjustment reference line is equal to the snow throwing inclination angle.

Furthering, the snow feeding component includes a snow feeding channel, a snow shovel, a snow feeding drive device, a lifting mechanism, an image sensor device and an image processing module; the snow feeding channel is communicated with the snow throwing component, and the lifting mechanism is connected with the snow feeding channel; the snow shovel is provided at a snow inlet of the snow feeding channel, and the snow feeding drive device is connected to the snow shovel; the image sensor device is provided in the snow feeding channel, and the image processing module is electrically connected to the image sensor device and the lifting mechanism; and
the performing the snow removal operation on the arrived grid includes:
driving, by the snow feeding drive device, the snow shovel to cut external snow, and continuously feeding the external snow into the snow feeding channel;
obtaining, by the image sensor device, a snow feeding image of the snow feeding channel, and transmitting the snow feeding image to the image processing module;
determining, by the image processing module, whether a proportion of the snow in the snow feeding image exceeds a first preset proportion threshold, and whether the proportion of the snow in the snow feeding image is lower than a second preset proportion threshold; wherein the first preset proportion threshold is higher than the second preset proportion threshold;
in response to the proportion exceeding the first preset proportion threshold, driving, by the lifting mechanism, the snow feeding channel to go up; and
in response to the proportion being less than the second preset proportion threshold, driving, by the lifting mechanism, the snow feeding channel to go down.

Furthering, the snow inlet is provided with an infrared sensor device electrically connected to the snow feeding drive device; and
after the driving, by the snow feeding drive device, the snow shovel to cut the external snow, and continuously feeding the external snow into the snow feeding channel, the method includes:
obtaining, by the infrared sensor device, a temperature signal at the snow inlet; and
in response to a fluctuation value of the temperature signal exceeding a preset temperature threshold, controlling the snow feeding drive device to stop working.

Furthering, the snow shovel is made of rubber.

The present application also provides a snow removal robot operated by the aforementioned smart snow removal method, and the snow removal robot includes:
a positioning module, configured to obtain the latitude and longitude coordinates of the target snow throwing area and the target snow removal area through GPS-RTK positioning technology to generate the snow removal map;
a rasterization module, configured to rasterize the snow removal map;
a potential field module, configured to assign the potential energy value to the grid located in the target snow removal area in the outward diffusion manner, starting from the grid located in the target snow throwing area, through the BFS algorithm; and
a driver module, configured to control the snow removal robot to travel on the uncleaned grid with the highest current potential energy value one by one, and perform the snow removal operation on the arrived grid.

The present application also provides a smart snow removal equipment. The smart snow removal equipment includes a controller and a memory. The memory stores at least one instruction or at least one program loaded and executed by the controller to implement the aforementioned smart snow removal method.

The present application provides a smart snow removal method, which generates a snow removal map using GPS-RTK positioning technology and rasterizes the snow removal map. Then, it applies a BFS algorithm to convert each grid into a potential field. Based on these settings, the snow removal robot can be controlled to travel on the uncleaned grid with the highest current potential energy value one by one, to perform the snow removal operation on the arrived grid. This method achieves the purpose of cleaning multiple areas with a single setting, improving snow removal efficiency while enhancing the intelligence level of the snow removal robot.

### BRIEF DESCRIPTION OF THE DRAWINGS

FIG. 1 is a schematic flowchart of a smart snow removal method according to an embodiment of the present application.

FIG. 2 is a first schematic diagram illustrating potential field values of grids in a smart snow removal method according to an embodiment of the present application.

FIG. 3 is a schematic diagram illustrating a first path planning for a snow removal robot in a smart snow removal method according to an embodiment of the present application.

FIG. 4 is a schematic diagram illustrating a second path planning for a snow removal robot in a smart snow removal method according to an embodiment of the present application.

FIG. 5 is a second schematic diagram illustrating potential field values of grids in a smart snow removal method according to an embodiment of the present application.

FIG. 6 is a schematic diagram illustrating a third path planning for a snow removal robot in a smart snow removal method according to an embodiment of the present application.

FIG. 7 is a first schematic diagram illustrating determination of a snow removal grid based on an angle method in a smart snow removal method according to an embodiment of the present application.

FIG. 8 is a second schematic diagram illustrating determination of a snow removal grid based on an angle method in a smart snow removal method according to an embodiment of the present application.

FIG. 9 is a first schematic diagram illustrating determination of a static obstacle grid based on an angle method in a smart snow removal method according to an embodiment of the present application.

FIG. 10 is a second schematic diagram illustrating determination of a static obstacle grid based on an angle method in a smart snow removal method according to an embodiment of the present application.

FIG. 11 is a third schematic diagram illustrating determination of a static obstacle grid based on an angle method in a smart snow removal method according to an embodiment of the present application.

FIG. 12 is a fourth schematic diagram illustrating determination of a static obstacle grid based on an angle method in a smart snow removal method according to an embodiment of the present application.

FIG. 13 is a schematic diagram of demarcating an adjustment reference line in a smart snow removal method according to an embodiment of the present application.

FIG. 14 is a structure diagram of a snow throwing component of a snow removal robot in a smart snow removal method according to an embodiment of the present application.

FIG. 15 is a schematic structural diagram of a snow removal robot according to the present application.

FIG. 16 is a schematic flowchart of a smart snow removal method according to another embodiment of the present application.

### DETAILED DESCRIPTION OF THE EMBODIMENTS

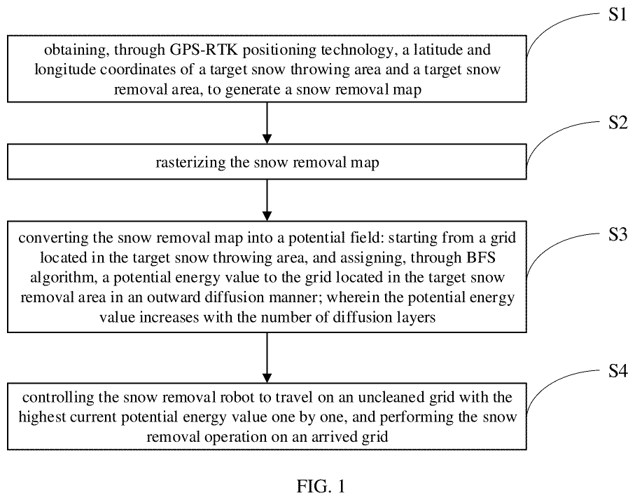

An embodiment of the present application provides a smart snow removal method for application to a snow removal robot, as shown in FIG. 1, which includes:
a traveling component, configured to travel along a planned path;
a snow feeding component, provided at the traveling component, and configured to collect snow during a snow removal operation; and
a snow throwing component, provided at the traveling component, connected to the snow feeding component, and configured to throw the snow collected by the snow feeding component to a preset area during the snow removal operation; and

The smart snow removal method includes:
S1, obtaining, through global positioning system real-time kinematic (GPS-RTK) positioning technology, a latitude and longitude coordinates of a target snow throwing area and a target snow removal area, to generate a snow removal map;
S2, rasterizing the snow removal map;
S3, converting the snow removal map into a potential field: starting from a grid located in the target snow throwing area, and assigning, through a breadth-first search (BFS) algorithm, a potential energy value to the grid located in the target snow removal area in an outward diffusion manner; the potential energy value increases with an increase in the number of diffusion layers; and
S4, controlling the snow removal robot to travel on an uncleaned grid with the highest current potential energy value one by one, and performing the snow removal operation on an arrived grid.

In an embodiment, the travelling component may include a chassis and a travelling wheel or track arranged on the chassis, which may be driven by a power device. The power device can be driven by converting energy such as electric energy and heat energy into mechanical energy. The snow feeding component may include a snow shovel and an accompanying drive device. The drive device drives the snow shovel to cut the snow in the target snow removal area and pushes the cut snow continuously in the direction of the snow throwing component through the motion of the snow shovel. The snow throwing component may include a snow throwing cylinder and an accompanying drive device. The driving device continuously throws the snow pushed by the snow feeding component into the snow throwing cylinder, which limits the direction of the snow exit through its internal channel. Snow can finally be thrown to the target snow throwing area at a preset angle through the guidance of the snow throwing cylinder, which does not affect the normal travel of pedestrians and vehicles, so as to achieve the purpose of clearing snow and avoiding snow blocking the road.

In the related art, ultra-wide band (UWB) tag wireless carrier communication is generally adopted to realize the positioning of the snowplow. Specifically, three mobile base stations with identification are used as the signal transmitting end, and the three mobile base stations are enclosed to form an electronic fence. The positioning rod of the snowplow is used as the signal receiving end. By obtaining the location information of the mobile base station, combining with the current driving speed, angular speed, direction and other information of the snow plow, the coordinates of the snow plow in the specified position are calculated. In this way, the internal program of the snow plow can realize the function of automatic snow removal by combining the obtained coordinate information with the path planning algorithm. The limitation of this technology is that the snow removal area is small (usually limited to 28 m×28 m area), and because three mobile base stations with identification are required as electronic fences, and a snow removal plan can only sweep the area surrounded by an electronic fence, so if the user needs to sweep multiple areas, the mobile base station needs to be moved. The goal of completing multiple snow removal programs in a single setup is not achieved.

Based on the above defects of the related art, this embodiment provides an smart snow removal method. Specifically, the GPS-RTK positioning technology is the related art, which can realize the accurate positioning of the snow removal robot through satellite and signal assisted base station. Specifically, the internal algorithm of the snow removal robot can be adapted to the position signal returned by GPS-RTK, so that the target snow throwing area and target snow removal area can be set within the coverage area of the satellite. In order to obtain accurate longitude and latitude coordinates of the snow removal map, breaking through the current positioning method of the snow removal area restrictions.

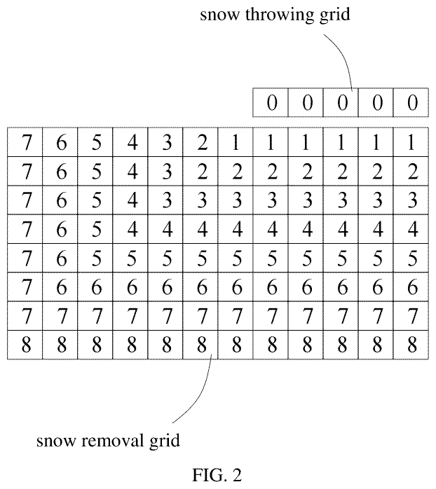

After the snow removal map is obtained, the snow removal map can be divided into several grids, and a corresponding potential energy value is set for each grid through BFS algorithm. For example, as shown in FIG. 2, the potential energy value of the grid where the target snow throwing area is located can be set to 0, and each time a layer is diffused outward from the target snow throwing area (that is, a layer is diffused to the target snow removal area), the potential energy value of the grid of the corresponding layer is increased by 1, and the potential energy value distribution image as shown in FIG. 2 is finally formed.

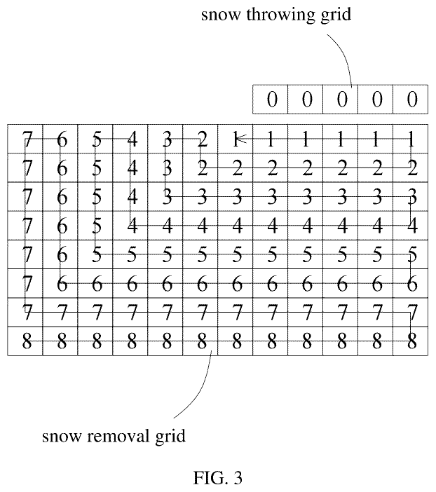

After the above potential field operation is completed, the snow removal robot can be controlled to start from any uncleaned grid with the highest current potential energy value (i.e., the uncleaned grid with a potential energy value of 8). When the snow removal robot finishes cleaning the grid, the grid will become cleaned (an electronic mark can be set at the corresponding position in the snow removal map to distinguish it from the grid in the uncleaned state). At this time, the snow removal robot will move to the next uncleaned grid with the highest current potential energy value (which can be an uncleaned grid with a potential energy value of 8 adjacent to the previous grid) and perform snow removal operations. It can be understood that when the snow removal robot has cleaned all grids with a potential energy value of 8, the “uncleared grid with the highest current potential energy value” becomes an uncleaned grid with a potential energy value of 7. At this time, the snow removal robot will move to the uncleaned grid with a potential energy value of 7 adjacent to the current grid to repeat the above cleaning and cruising operations. Based on the above path planning method, the travel path of the snow removal robot will be as shown in FIG. 3. It can be seen that when there is a boundary between the target snow removal area and the target snow throwing area, after the snow removal robot completes the snow removal operation for all grids with a potential energy value of 1, the snow removal robot moves to the vicinity of the target snow throwing area. At this time, the next moving target of the snow removal robot can only be the grid where the target snow throwing area with a potential energy value of 0 is located, that is, the snow removal robot has completed the snow removal operation for all grids where the target snow removal area is located. In addition, when there is no boundary between the target snow removal area and the target snow throwing area, after the snow removal robot completes the snow removal operation for all grids with a potential energy value of 1, the snow removal robot does not move to the vicinity of the target snow throwing area. At this time, it can also be considered that the snow removal robot has completed the snow removal operation for all grids where the target snow removal area is located.

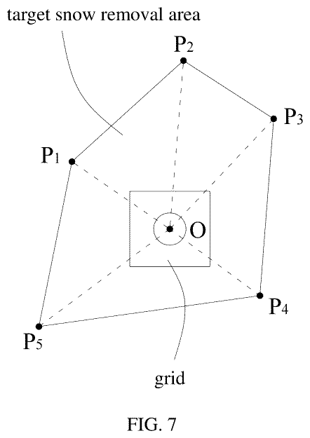

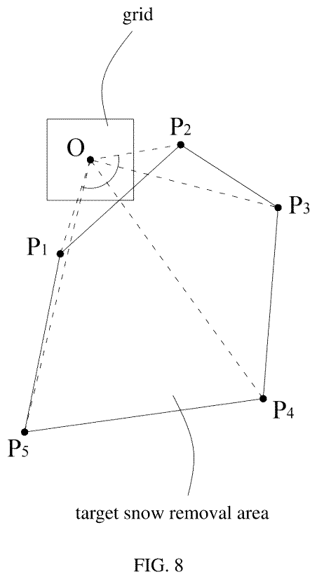

Further, referring to FIG. 7 and FIG. 8, in an embodiment, after the rasterizing the snow removal map, the method includes:
determining, through an angle method, whether each grid is located in the target snow removal area: taking a connection line between a center point of each grid and each vertex of the target snow removal area as a first auxiliary line, and determining whether the sum of the angles between all the first auxiliary lines corresponding to the center point is 360°; if so, determining that the corresponding grid is located in the target snow removal area;
setting the grid in the target snow removal area as a snow removal grid; and setting the grid in the target snow throwing area as a snow throwing grid;
the starting from a grid located in the target snow throwing area, and assigning, through a BFS algorithm, a potential energy value to the grid located in the target snow removal area in an outward diffusion manner includes:
starting from the snow throwing grid, and assigning, through the BFS algorithm, the potential energy value to the snow removal grid in the outward diffusion manner.

After rasterizing the snow removal map, it is necessary to determine whether each grid is located in the target snow removal area. Specifically, referring to FIG. 7, on the horizontal projection plane, the lines (i.e., the first auxiliary lines) between the center point O of the grid and the five vertices P₁, P₂, P₃, P₄ and P₅ of the target snow removal area are OP₁, OP₂, OP₃, OP₄ and OP₅, respectively. The five angles between the five first auxiliary lines are ∠P₁OP₂, ∠P₂OP₃, ∠P₃OP₄, ∠P₄OP₅ and ∠P₅OP₁, and the sum of the angles is equal to 360°. In this way, it can be determined that the grid is located in the target snow removal area (i.e., the grid is set as a snow removal grid). Referring to FIG. 8, on the horizontal projection plane, the lines (i.e., the first auxiliary lines) between the center point O of the grid and the five vertices P₁, P₂, P₃, P₄ and P₅ of the target snow removal area are OP₁, OP₂, OP₃, OP₄ and OP₅, respectively. The four angles between the five first auxiliary lines are ∠P₁OP₅, ∠P₅OP₄, ∠P₄OP₃ and ∠P₃OP₂, and the sum of the angles is less than 360°. In this way, it can be determined that the grid is not within the target snow removal area.

After all snow removal grids are determined by the above method, a basis can be provided for subsequent potential field operation to define the path for subsequent snow removal robots to travel in the target snow removal area.

Further, referring to FIG. 7 and FIG. 8, in an embodiment, the taking a connection line between a center point of each grid and each vertex of the target snow removal area as a first auxiliary line, and determining whether the sum of the angles between all the first auxiliary lines corresponding to the center point is 360° includes:
determining whether the center point satisfies the following formula:

$${\sum }_{i ∈ P , j = i + 1 ( next )} {sin}^{- 1} ( \frac{\begin{matrix}\to \\ {OP}_{i}\end{matrix} \times \begin{matrix}\to \\ {OP}_{j}\end{matrix}}{\vert \begin{matrix}\to \\ {OP}_{i}\end{matrix} \vert * \vert \begin{matrix}\to \\ {OP}_{j}\end{matrix} \vert} ) = 2 k π ( k ϵ Z )$$

where O represents a coordinates of the center point, Pᵢ and Pⱼ represent a coordinates of two adjacent vertices in the target snow removal area, a superscripts of \vec{OPᵢ} and \vec{OPⱼ} represent vector symbols, and Z represents a set of integers; this formula is a modified form of the vector intersection formula a*b=|a||b|sinα (a and b are both vectors, and α is the angle between vectors a and b).
if so, determining the sum of the angles between all the first auxiliary lines corresponding to the center point is 360°.

The coordinates of O, Pᵢ and Pⱼ can be obtained through GPS-RTK positioning technology. Based on the above-mentioned vector cross multiplication method, it is convenient to determine whether the sum of the angles between all the first auxiliary lines corresponding to the center point of the grid is equal to 360°, thereby quickly determining the snow removal grid.

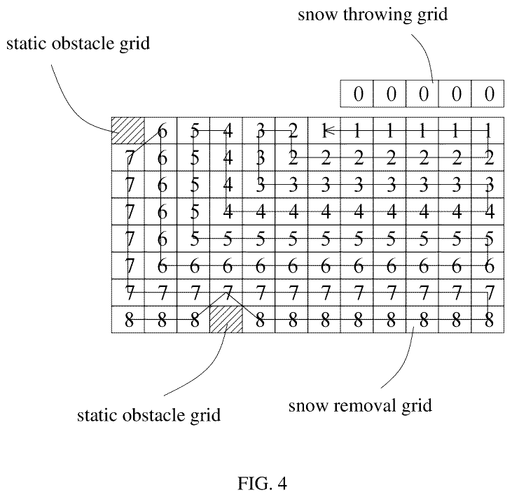

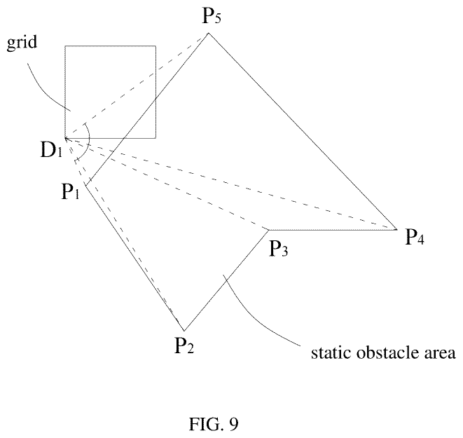

Further, referring to FIG. 4, FIG. 9 to FIG. 12, in an embodiment, the obtaining, through GPS-RTK positioning technology, a latitude and longitude coordinates of a target snow throwing area and a target snow removal area, to generate a snow removal map includes:
obtaining, through GPS-RTK positioning technology, the latitude and longitude coordinates of the target snow throwing area, the target snow removal area and a static obstacle area, to generate the snow removal map;
after the rasterizing the snow removal map, the method includes:
determining, through the angle method, whether each grid overlaps with the static obstacle area: taking the connection between each grid vertex of every grid to each vertex of the static obstacle area as a second auxiliary line, and determining whether the sum of the angles between all the second auxiliary lines corresponding to each grid vertex is 360°; if the sum of the angles between all the second auxiliary lines corresponding to any grid vertex of any grid is 360°, determining that the corresponding grid overlaps with the static obstacle area;
setting the grid overlapping with the static obstacle area as a static obstacle grid;
before the starting from the snow throwing grid, and assigning, through the BFS algorithm, the potential energy value to the snow removal grid in the outward diffusion manner, the method includes:
determining whether there is the static obstacle grid in the snow removal grid; if so, removing the static obstacle grid from the snow removal grid.

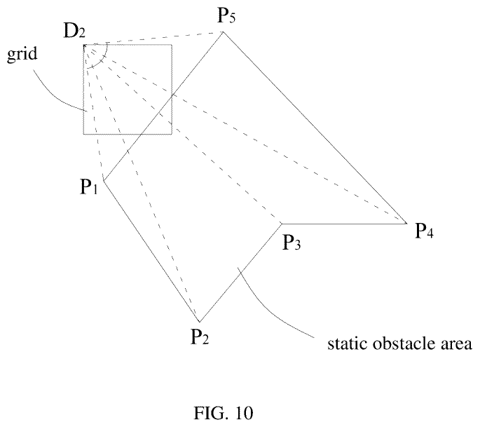

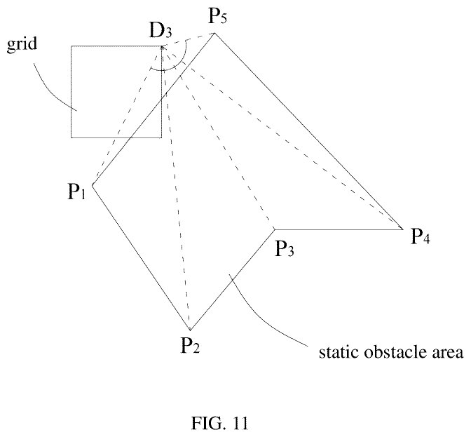

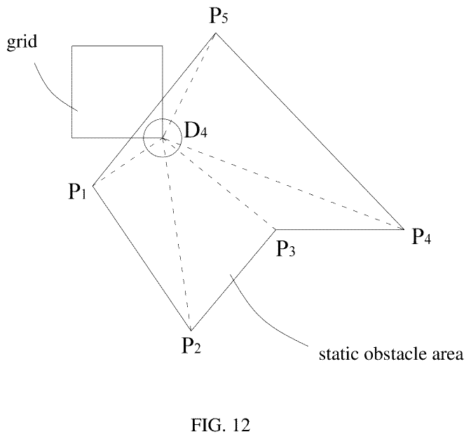

Static obstacles are obstacles set at fixed positions in the target snow removal area. After the snow removal map is rasterized, it is necessary to determine the grid occupied by the static obstacle to prevent the snow removal robot from entering the grid and colliding with the static obstacle during the subsequent movement. Specifically, on the horizontal projection plane, the lines (i.e., the second auxiliary lines) between the four grid vertices D₁, D₂, D₃ and D₄ of the grid and the five vertices P₁, P₂, P₃, P₄ and P₅ of the static obstacle area are shown in FIGS. 9 to 12. Among them, referring to FIG. 9, the four angles between the five second auxiliary lines corresponding to the first grid vertex D₁ are ∠P₁D₁P₂, ∠P₂D₁P₃, ∠P₃D₁P₄ and ∠P₄D₁P₅, and the sum of the angles is less than 360°. It can be determined that the first grid vertex D₁ is outside the static obstacle area. Referring to FIG. 10, the four angles between the five second auxiliary lines corresponding to the second grid vertex D₂ are ∠P₁D₂P₂, ∠P₂D₂P₃, ∠P₃D₂P₄ and ∠P₄D₂P₅, and the sum of the angles is less than 360°. It can be determined that the second grid vertex D₂ is outside the static obstacle area. Referring to FIG. 11, the four angles between the five second auxiliary lines corresponding to the third grid vertex D₃ are ∠P₁D₃P₂, ∠P₂D₃P₃, ∠P₃D₃P₄ and ∠P₄D₃P₅, and the sum of the angles is less than 360°. It can be determined that the third grid vertex D₃ is outside the static obstacle area. Referring to FIG. 12, the five angles between the five second auxiliary lines corresponding to the fourth grid vertex D₄ are ∠P₁D₄P₂, ∠P₂D₄P₃, ∠P₃D₄P₄, ∠P₄D₄P₅ and ∠P₅D₄P₁, respectively, and the sum of the angles is equal to 360°. It can be determined that the fourth grid vertex D₄ is located in the static obstacle area. In summary, since the grid has a grid vertex located in the static obstacle area (i.e., the fourth grid vertex D₄ mentioned above), it can be determined that the grid overlaps with the static obstacle area, and the grid is set as a static obstacle grid.

After all static obstacle grids are determined by the above method, the static obstacle grids in the snow removal grid can be removed, so that the static obstacle grids do not participate in the subsequent potential field operation and cannot be assigned potential energy values. Referring to the planned path after removing the static obstacle grids in FIG. 4, since the travel path of the snow removal robot is always located on the grid with the potential energy value, the above operation can avoid the snow removal robot from entering the static obstacle grid and colliding, thereby realizing the automatic obstacle avoidance function of the snow removal robot.

Further, referring to FIG. 9 to FIG. 12, in an embodiment, the taking the connection between each grid vertex of every grid to each vertex of the static obstacle area as a second auxiliary line, and determining whether the sum of the angles between all the second auxiliary lines corresponding to each grid vertex is 360° includes:
determining whether the grid vertices satisfy the following formula:

$${\sum }_{i ∈ P , j = i + 1 ( next )} {sin}^{- 1} ( \frac{\begin{matrix}\to \\ {DP}_{i}\end{matrix} \times \begin{matrix}\to \\ {DP}_{j}\end{matrix}}{\vert \begin{matrix}\to \\ {DP}_{i}\end{matrix} \vert * \vert \begin{matrix}\to \\ {DP}_{j}\end{matrix} \vert} ) = 2 k π ( k ϵ Z )$$

where D represents the coordinates of the grid vertices, Pᵢ and Pⱼ represent the coordinates of two adjacent vertices in the target snow removal area, the superscripts of \vec{DPᵢ} and \vec{DPⱼ} represent vector symbols, and Z represents the set of integers;
if so, determining the sum of the angles between all the second auxiliary lines corresponding to the grid vertices is 360°.

The coordinates of D, Pᵢ and Pⱼ can be obtained through GPS-RTK positioning technology. Based on the above-mentioned vector cross multiplication method, it is convenient to determine whether the sum of the angles between all the second auxiliary lines corresponding to the grid vertices is equal to 360°, thereby quickly determining the static obstacle grid.

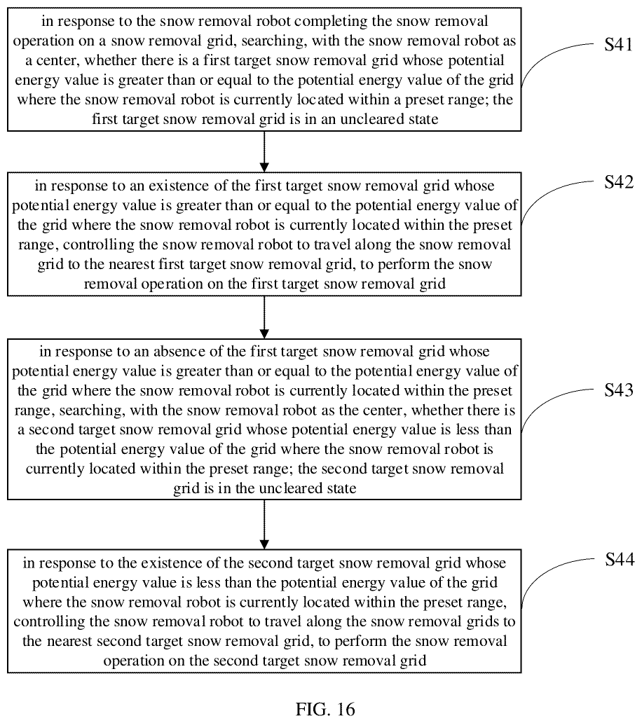

Further, referring to FIG. 2 to FIG. 6 and FIG. 16, in an embodiment, the controlling the snow removal robot to travel on an uncleaned grid with the highest current potential energy value one by one, and performing the snow removal operation on an arrived grid includes:
S41, in response to the snow removal robot completing the snow removal operation on a snow removal grid, searching, with the snow removal robot as a center, whether there is a first target snow removal grid whose potential energy value is greater than or equal to the potential energy value of the grid where the snow removal robot is currently located within a preset range; the first target snow removal grid is in an uncleared state;
S42, in response to an existence of the first target snow removal grid whose potential energy value is greater than or equal to the potential energy value of the grid where the snow removal robot is currently located within the preset range, controlling the snow removal robot to travel along the snow removal grid to the nearest first target snow removal grid, to perform the snow removal operation on the first target snow removal grid;
S43, in response to an absence of the first target snow removal grid whose potential energy value is greater than or equal to the potential energy value of the grid where the snow removal robot is currently located within the preset range, searching, with the snow removal robot as the center, whether there is a second target snow removal grid whose potential energy value is less than the potential energy value of the grid where the snow removal robot is currently located within the preset range; the second target snow removal grid is in the uncleared state; and
S44, in response to the existence of the second target snow removal grid whose potential energy value is less than the potential energy value of the grid where the snow removal robot is currently located within the preset range, controlling the snow removal robot to travel along the snow removal grids to the nearest second target snow removal grid, to perform the snow removal operation on the second target snow removal grid.

Specifically, the above-mentioned preset range can be within the range of multiple grids centered on the snow removal robot, for example, within the range of eight grids centered on the snow removal robot. Referring to FIG. 3, after the potential field operation is completed, the snow removal robot can be controlled to start from any uncleaned grid with the highest current potential energy value (i.e., an uncleaned grid with a potential energy value of 8). When the snow removal robot finishes cleaning the grid, the grid will become cleaned (an electronic mark can be set at the corresponding position in the snow removal map to distinguish it from the grid in the uncleaned state). At this time, the snow removal robot will move to the next uncleaned grid with a potential energy value greater than or equal to the potential energy value of the current grid and the closest distance (i.e., the first target snow removal grid with a potential energy value of 8 adjacent to the grid where the snow removal robot is currently located) to perform snow removal operations, and repeat the above steps. When the snow removal robot has cleared all grids with a potential energy value of 8, there are no uncleaned grids with potential energy values greater than or equal to the potential energy value of the grid where the snow removal robot is currently located within the preset range. At this time, the snow removal robot searches for uncleaned grids with a potential energy value of 7 (i.e., the second target snow removal grid) within the preset range, and controls the snow removal robot to move to the nearest second target snow removal grid (i.e., the second target snow removal grid with a potential energy value of 7 adjacent to the grid where the snow removal robot is currently located) to perform snow removal operations, and repeats the above steps; until the snow removal robot completes the snow removal operations on all snow removal grids according to the planned path shown in FIG. 3.

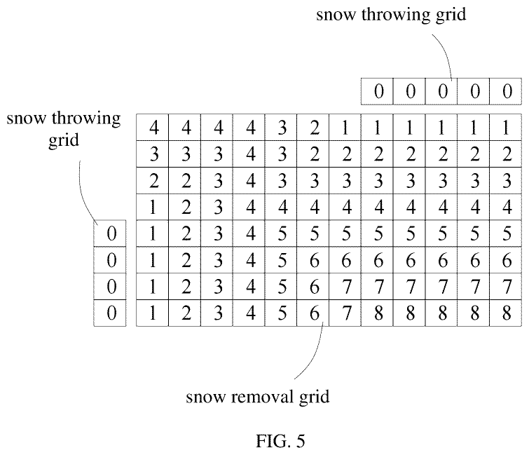

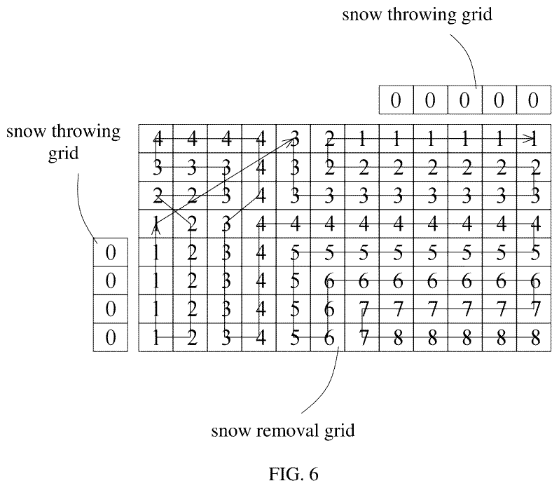

Further, referring to FIG. 5 and FIG. 6, in an embodiment, after the searching, with the snow removal robot as the center, whether there is a second target snow removal grid whose potential energy value is less than the potential energy value of the grid where the snow removal robot is currently located within the preset range, the method includes:
in response to the absence of the second target snow removal grid whose potential energy value is less than the potential energy value of the grid where the snow removal robot is currently located within the preset range, searching, with the snow removal robot as the center, whether there is the snow throwing grid within the preset range;
in response to the existence of the snow throwing grid within the preset range, searching whether there is a third target snow removal grid uncleared in the snow removal map;
in response to the existence of the third target snow removal grid in the snow removal map, controlling, through a D*Lite algorithm, the snow removal robot to travel along the snow removal grid to the third target snow removal grid with the highest potential energy value, to perform the snow removal operation on the third target snow removal grid; and
in response to the snow removal robot completing the snow removal operation on the third target snow removal grid, repeating the step of searching, with the snow removal robot as a center, whether there is a first target snow removal grid whose potential energy value is greater than or equal to the potential energy value of the grid where the snow removal robot is currently located within a preset range.

When multiple snow throwing grids are set, after the potential field operation is performed with multiple snow throwing grids as the starting point, the grid potential energy value distribution image is shown in FIG. 5. Taking the two snow throwing grids shown in FIGS. 5 and 6 as an example, when the snow removal robot travels to the vicinity of the snow throwing grid on the left according to the above-mentioned path planning method, and clears all the snow removal grids with a potential energy value of 1 on the outer layer of the snow throwing grid, there are actually still uncleared snow removal grids in the snow removal map (i.e., uncleared snow removal grids near the snow throwing grid on the right). At this time, the D*Lite path planning algorithm can be used to search for the uncleared third target snow removal grid in the snow removal map, and the snow removal robot can be controlled to travel to the third target snow removal grid with the highest potential energy value (that is, the third target snow removal grid with a potential energy value of 3, which is located near the snow throwing grid on the right side of the figure) to perform snow removal operations. After cleaning, the grid where the snow removal robot is currently located is taken as the starting point, and the traveling and snow removal operations in steps S41-S44 are repeated according to the above-mentioned path planning method until the snow removal robot has cleared all the snow removal grids with a potential energy value of 1 on the outer layer of the snow throwing grid on the right. At this time, the cleaning work for all snow removal grids in the snow removal map is completed; the traveling path of the snow removal robot is shown in FIG. 6.

Further, referring to FIG. 2 to FIG. 6, in an embodiment, the performing the snow removal operation on an arrived grid includes:
collecting snow by the snow feeding component;
determining whether there is the snow throwing grid in the preset range;
in response to the absence of the snow throwing grid in the preset range, taking, as an actual snow throwing grid, the uncleared snow removal grid whose potential energy value is the lowest in the preset range;
in response to the existence of the snow throwing grid in the preset range, taking the snow throwing grid as the actual snow throwing grid; and
directing a snow throwing direction of the snow throwing component toward the actual snow throwing grid.

The snow throwing strategy provided in this embodiment can ensure that the snow throwing direction is always toward the uncleaned grid whose potential energy value is less than the potential energy value of the grid where the snow removal robot is currently located, waiting for subsequent cleaning. As shown in FIGS. 3, 4 and 6, when the snow removal robot is traveling on a snow removal grid with a potential energy value of 8, the snow removal grid with a potential energy value of 7 can be used as the actual snow throwing grid. In this way, when the snow removal robot travels to the snow removal grid with a potential energy value of 7, the previously scattered snow can be swept together; when the snow removal robot travels on the snow removal grid with a potential energy value of 1, the snow throwing grid next to it can be used as the actual snow throwing grid. Through the above operation, it can be avoided that the snow is accidentally thrown to the grid that has been cleaned, thereby destroying the snow removal effect.

Further, in an embodiment, an uncleaned mark is set on the snow throwing grid and on the snow removal grid where the snow removal robot has not performed snow removal operation; and a cleared mark is set on the snow removal grid where the snow removal robot has completed snow removal operation.

By setting marks, the cleaning status of each grid can be recorded in real time to ensure the accuracy of path planning.

Further, in an embodiment, the traveling component is provided with a millimeter wave radar sensor device;
the controlling the snow removal robot to travel along the snow removal grid to the nearest first target snow removal grid, to perform the snow removal operation on the first target snow removal grid includes:
in response to the snow removal robot traveling toward the nearest first target snow removal grid, performing, by the millimeter wave radar sensor device, dynamic obstacle detection on a traveling path;
in response to the millimeter wave radar sensor device detecting a dynamic obstacle in front of the snow removal robot, controlling the snow removal robot to stop traveling;
obtaining, by the millimeter wave radar sensor device, a dynamic obstacle information, to mark the grid overlapping with the dynamic obstacle as a dynamic obstacle grid; and
excluding the dynamic obstacle grid from the snow removal grid, and repeating the step of searching, with the snow removal robot as a center, whether there is a first target snow removal grid whose potential energy value is greater than or equal to the potential energy value of the grid where the snow removal robot is currently located within a preset range.

Further, in an embodiment, the traveling component is provided with a millimeter wave radar sensor device; and
the controlling the snow removal robot to travel along the snow removal grid to the nearest second target snow removal grid, to perform the snow removal operation on the second target snow removal grid includes:
in response to the snow removal robot traveling toward the nearest second target snow removal grid, performing, by the millimeter wave radar sensor device, dynamic obstacle detection on the traveling path;
in response to the millimeter wave radar sensor device detecting the dynamic obstacle in front of the snow removal robot, controlling the snow removal robot to stop traveling;
obtaining, by the millimeter wave radar sensor device, the dynamic obstacle information, to mark the grid overlapping with the dynamic obstacle as the dynamic obstacle grid; and
excluding the dynamic obstacle grid from the snow removal grid, and repeating the step of searching, with the snow removal robot as the center, whether there is a second target snow removal grid whose potential energy value is less than the potential energy value of the grid where the snow removal robot is currently located within the preset range.

Dynamic obstacles are obstacles that temporarily appear in the target snow removal area during the movement of the snow removal robot. With the help of the millimeter wave radar sensor device, dynamic obstacles in the direction of the snow removal robot can be detected to control the snow removal robot to stop traveling in time to avoid collision. Through the combination of the millimeter wave radar sensor device and the GPS-RTK positioning technology, the specific coordinates and other information of the dynamic obstacles can be obtained, so that the dynamic obstacle grid can be determined by the above-mentioned angle method of determining the snow removal grid and the static obstacle grid. After determining the dynamic obstacle grid, the dynamic obstacle grid existing in the snow removal grid can be removed, and the above-mentioned path planning operation for the snow removal grid can be performed again based on the grid where the snow removal robot is currently located, so that the dynamic obstacle grid does not participate in the path planning operation. Since the travel path of the snow removal robot is always located on the snow removal grid with a potential energy value, after the dynamic obstacle grid is removed from the snow removal grid, the snow removal robot can be prevented from entering the dynamic obstacle grid during the movement and colliding, thereby further improving the automatic obstacle avoidance function of the snow removal robot.

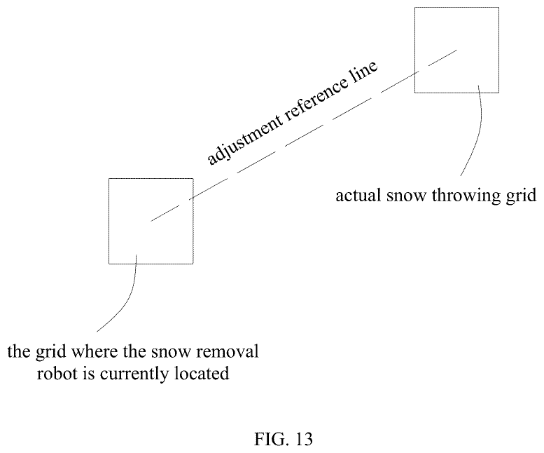

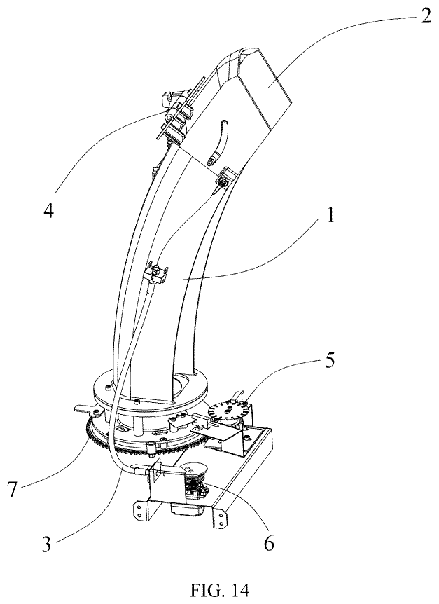

Further, referring to FIG. 13 and FIG. 14, in an embodiment, the directing a snow throwing direction of the snow throwing component toward the actual snow throwing grid includes:
obtaining, through GPS-RTK positioning technology, a first relative position information between the grid where the snow removal robot is currently located and the actual snow throwing grid; and
adjusting, according to the first relative position information, the snow throwing angle of the snow throwing component.

In an embodiment, referring to FIG. 14, the snow throwing component includes a snow throwing drive device, a first rotary drive device 5, a second rotary drive device 6, a snow throwing cylinder 1 and a snow throwing cylinder cover 2; the bottom of the snow throwing cylinder 1 is rotatably connected to the traveling component along the vertical axis through a rotary base 7, and the snow throwing cylinder cover 2 is rotatably connected to the top of the snow throwing cylinder 1 along the horizontal axis through a rotary mechanism 4; the rotary mechanism 4 may include any related device with a hinged function; the bottom of the snow throwing cylinder 1 is connected to the snow feeding component, and the top of the snow throwing cylinder 1 is connected to one end of the snow throwing cylinder cover 2; the snow throwing drive device is arranged between the bottom of the snow throwing cylinder 1 and the snow feeding component, the first rotary drive device 5 is transmission-connected to the rotary base 7, and the second rotary drive device 6 is connected to the snow throwing cylinder cover 2 through a connecting member 3 (specifically, a wire rope); the snow throwing drive device is used to push the snow collected by the snow feeding component into the snow throwing cylinder 1, and finally throw the snow out from the other end of the snow throwing cylinder cover 2;
the obtaining, through GPS-RTK positioning technology, a first relative position information between the grid where the snow removal robot is currently located and the actual snow throwing grid includes:
obtaining, through GPS-RTK positioning technology, a first center point coordinates of the grid where the snow removal robot is currently located and a second center point coordinates of the actual snow throwing grid; taking a horizontal line between the first center point coordinates and the second center point coordinates as an adjustment reference line, and obtaining the length of the adjustment reference line;
driving, by the first rotary drive device 5, the rotary base 7 to rotate to drive the snow throwing cylinder 1 to rotate, so that the horizontal angle between the direction of the upper end opening of the snow throwing cylinder cover 2 on the horizontal plane and the adjustment reference line is less than a first preset angle;
calculating the snow throwing inclination angle based on the length of the adjustment reference line, and the second rotary drive device 6 driving, through the connecting member 3, the snow throwing cylinder cover 2 to rotate, so that the vertical angle between the direction of the upper end opening of the snow throwing cylinder cover 2 on the vertical plane and the adjustment reference line is equal to the snow throwing inclination angle.

The snow throwing drive device can be configured as a blade structure driven by a motor. The blade is driven by the motor to rotate continuously, the blade can receive the snow pushed by the snow feeding component and continuously throw the snow into the snow throwing cylinder 1 and the snow throwing cylinder cover 2 above, and finally throw the snow from the upper opening of the snow throwing cylinder cover 2. Since the upper opening of the snow throwing cylinder cover 2 has a certain inclination angle relative to the lower end of the snow throwing cylinder cover 2, the movement trajectory of the snow after being thrown is in a certain parabolic shape.

After obtaining the relative angle position between the grid where the snow removal robot is currently located and the actual snow throwing grid through GPS-RTK positioning technology, the first rotary drive device 5 can be controlled to move based on a preset program to drive the rotary base 7 to drive the snow throwing cylinder 1 to rotate on the horizontal plane (the snow throwing cylinder cover 2 also rotates with the snow throwing cylinder 1), so that the upper end opening of the snow throwing cylinder cover 2 points to the actual snow throwing grid in the horizontal direction, thereby achieving the adjustment of the horizontal snow throwing angle of the snow throwing cylinder cover 2. It can be understood that by setting the first preset angle, the horizontal snow throwing angle of the snow throwing cylinder cover 2 can be allowed to have a certain error; specifically, the first preset angle can be set to 5°. When the horizontal angle between the direction of the upper end opening of the snow throwing cylinder cover 2 on the horizontal plane and the adjustment reference line is ±5°, it can be considered that the horizontal snow throwing angle of the snow throwing cylinder cover 2 has been adjusted to the right position.

After obtaining the straight-line distance between the grid where the snow removal robot is currently located and the actual snow throwing grid (i.e., the length of the adjustment reference line) through GPS-RTK positioning technology, the theoretical snow throwing inclination angle of the snow throwing cylinder cover 2 can be calculated by combining the straight-line distance with parameters such as the snow throwing speed. Based on the preset program, the second rotary drive device 6 is controlled to operate so as to drive the snow throwing cylinder cover 2 to rotate on the vertical plane through the connecting member 3, so that the angle between the upper end opening of the snow throwing cylinder cover 2 and the horizontal plane is equal to the calculated snow throwing inclination angle, thereby realizing the adjustment of the vertical snow throwing angle of the snow throwing cylinder cover 2.

Through the above operation, the purpose of adjusting the snow throwing angle in real time according to the different snow throwing areas is achieved.

Further, in an embodiment, the snow feeding component includes a snow feeding channel, a snow shovel, a snow feeding drive device, a lifting mechanism, an image sensor device and an image processing module; the snow feeding channel is connected to the snow throwing component, and the lifting mechanism is connected with the snow feeding channel; the snow shovel is provided at a snow inlet of the snow feeding channel, and the snow feeding drive device is connected to the snow shovel; the image sensor device is provided in the snow feeding channel, and the image processing module is electrically connected to the image sensor device and the lifting mechanism; and
the performing the snow removal operation on an arrived grid includes:
driving, by the snow feeding drive device, the snow shovel to cut external snow, and continuously feeding the external snow into the snow feeding channel;
obtaining, by the image sensor device, a snow feeding image of the snow feeding channel, and transmitting the snow feeding image to the image processing module;
determining, by the image processing module, whether a proportion of the snow in the snow feeding image exceeds a first preset proportion threshold, and whether the proportion of the snow in the snow feeding image is lower than a second preset proportion threshold; the first preset proportion threshold is higher than the second preset proportion threshold;
in response to the proportion exceeding the first preset proportion threshold, driving, by the lifting mechanism, the snow feeding channel to go up; and
in response to the proportion being less than the second preset proportion threshold, driving, by the lifting mechanism, the snow feeding channel to go down.

Through the above operation, the purpose of automatically adjusting the height of the snow feeding channel according to the amount of snow entering is achieved. Specifically, the first preset ratio threshold is set to 80%, and the second preset ratio threshold is set to 20%; if the calculated screen ratio of snow in the snow feeding image exceeds 80%, it means that the current amount of snow entering is large, the height of the snow feeding channel is low, and the height of the snow feeding channel needs to be appropriately increased; if the calculated screen ratio of snow in the snow feeding image is less than 20%, it means that the current amount of snow entering is small, the height of the snow feeding channel is high, and the height of the snow feeding channel needs to be appropriately lowered.

Further, in an embodiment, the snow inlet is provided with an infrared sensor device electrically connected to the snow feeding drive device; and
after the driving, by the snow feeding drive device, the snow shovel to cut the external snow, and continuously feeding the external snow into the snow feeding channel, the method includes:
obtaining, by the infrared sensor device, a temperature signal at the snow inlet; and
in response to a fluctuation value of the temperature signal exceeding a preset temperature threshold, controlling the snow feeding drive device to stop working.

Based on the consideration that the temperature of the living body is significantly higher than the temperature of the snow, this embodiment uses an infrared sensor device to detect the snow inlet. When the temperature signal acquired by the infrared sensor device fluctuates greatly, it means that the user's body parts or small animals appear at the snow inlet and may be involved in the snow inlet. At this time, the snow drive device can be controlled to stop working in time based on the preset program (for example, turning off the drive motor to stop the snow shovel from rotating) to prevent unnecessary dangers, thus improving the safety performance of the snow removal robot.

Further, in an embodiment, the snow shovel is made of rubber.

Setting the snow shovel to rubber material can help increase the tolerance and permeability of the snow shovel, adapt to different road conditions, and improve the safety factor during cutting ice and snow.

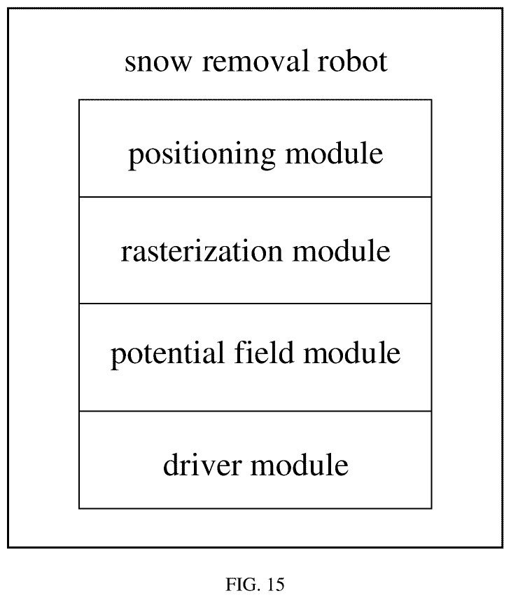

Referring to FIG. 15, the present application further provides a snow removal robot, which operates using the above-mentioned smart snow removal method. The snow removal robot includes:
a positioning module, configured to obtain the latitude and longitude coordinates of the target snow throwing area and the target snow removal area through GPS-RTK positioning technology to generate the snow removal map;
a rasterization module, configured to rasterize the snow removal map;
a potential field module, configured to assign the potential energy value to the grid located in the target snow removal area in the outward diffusion manner, starting from the grid located in the target snow throwing area, through the BFS algorithm; and
a driver module, configured to control the snow removal robot to travel on the uncleaned grid with the highest current potential energy value one by one, and perform the snow removal operation on the arrived grid.

Since the snow removal robot adopts all the technical solutions of all the embodiments of the above-mentioned smart snow removal method, it at least has all the beneficial effects brought by the technical solutions of the above-mentioned embodiments, which will not be described one by one here.

The present application also provides a smart snow removal equipment, which includes a controller and a memory. The memory stores at least one instruction or at least one program loaded and executed by the controller to implement the above-mentioned smart snow removal method.

Since the smart snow removal equipment adopts all the technical solutions of all the embodiments of the above-mentioned smart snow removal method, it at least has all the beneficial effects brought by the technical solutions of the above-mentioned embodiments, which will not be described one by one here.

It should be noted that if there are directional indications (such as up, down, left, right, front, back, etc.) in the embodiments of the present application, the directional indications are only used to explain the relative position relationship and movement of the components in a certain posture. If the specific posture changes, the directional indication will also change accordingly.

In addition, if there are descriptions involving “first”, “second”, etc. in the embodiments of the present application, the descriptions of “first”, “second”, etc. are only for descriptive purposes and cannot be understood as indicating or implying their relative importance or implicitly indicating the number of technical features indicated. Therefore, the features limited to “first” and “second” can explicitly or implicitly include at least one of the features. In addition, if “and/or” appears in the full text, its meaning includes three parallel schemes. Taking “A and/or B” as an example, it includes scheme A, or scheme B, or schemes that A and B meet at the same time. In addition, the technical solutions between the various embodiments can be combined with each other, but it must be based on the ability of those skilled in the art to implement. When the combination of technical solutions is contradictory or cannot be implemented, it should be considered that such a combination of technical solutions does not exist and is not within the scope of protection required by the present application.

According to the disclosure and teaching of the above description, those skilled in the art of the present application may also change and modify the above implementation. Therefore, the present application is not limited to the specific implementation disclosed and described above, and some modifications and changes to the present application should also fall within the scope of protection of the claims of the present application. In addition, although some specific terms are used in this specification, these terms are only for the convenience of description and do not constitute any limitation to the present application.

What is claimed is:

1. A smart snow removal method, applied to a snow removal robot, wherein the snow removal robot comprises:
a traveling component, configured to travel along a planned path;
a snow feeding component, provided at the traveling component, and configured to collect snow during a snow removal operation; and
a snow throwing component, provided at the traveling component, connected to the snow feeding component, and configured to throw the snow collected by the snow feeding component to a preset area during the snow removal operation;
the smart snow removal method comprises:
obtaining, through global positioning system real-time kinematic (GPS-RTK) positioning technology, a latitude and longitude coordinates of a target snow throwing area and a target snow removal area, to generate a snow removal map;
rasterizing the snow removal map;
converting the snow removal map into a potential field: starting from a grid located in the target snow throwing area, and assigning, through a breadth-first search (BFS) algorithm, a potential energy value to the grid located in the target snow removal area in an outward diffusion manner; wherein the potential energy value increases with an increase in a number of diffusion layers; and
controlling the snow removal robot to travel on an uncleaned grid with a highest current potential energy value one by one, and performing the snow removal operation on an arrived grid.

2. The smart snow removal method according to claim 1, wherein after the rasterizing the snow removal map, the method further comprises:
determining, through an angle method, whether each grid is located in the target snow removal area: taking a connection line between a center point of each grid and each vertex of the target snow removal area as a first auxiliary line, and determining whether a sum of angles between all the first auxiliary lines corresponding to the center point is 360°; in response to that the sum of the angles between all the first auxiliary lines corresponding to the center point is 360°, determining that a corresponding grid is located in the target snow removal area;
setting the grid in the target snow removal area as a snow removal grid; and
setting the grid in the target snow throwing area as a snow throwing grid;
wherein the starting from the grid located in the target snow throwing area, and assigning, through the BFS algorithm, the potential energy value to the grid located in the target snow removal area in the outward diffusion manner comprises:
starting from the snow throwing grid, and assigning, through the BFS algorithm, the potential energy value to the snow removal grid in the outward diffusion manner.

3. The smart snow removal method according to claim 2, wherein the obtaining, through GPS-RTK positioning technology, the latitude and longitude coordinates of the target snow throwing area and the target snow removal area, to generate the snow removal map comprises:
obtaining, through GPS-RTK positioning technology, the latitude and longitude coordinates of the target snow throwing area, the target snow removal area and a static obstacle area, to generate the snow removal map;
wherein after the rasterizing the snow removal map, the method further comprises:
determining, through the angle method, whether each grid overlaps with the static obstacle area: taking the connection line between each grid vertex of every grid and each vertex of the static obstacle area as a second auxiliary line, and determining whether the sum of angles between all the second auxiliary lines corresponding to each grid vertex is 360°; in response to that the sum of angles between all the second auxiliary lines corresponding to each grid vertex is 360°, determining that the corresponding grid overlaps with the static obstacle area; and
setting the grid overlapping with the static obstacle area as a static obstacle grid;
wherein before the starting from the snow throwing grid, and assigning, through the BFS algorithm, the potential energy value to the snow removal grid in the outward diffusion manner, the method further comprises:
determining whether there is the static obstacle grid in the snow removal grid; in response to that there is the static obstacle grid in the snow removal grid, removing the static obstacle grid from the snow removal grid.

4. The smart snow removal method according to claim 2, wherein the taking the connection line between the center point of each grid and each vertex of the target snow removal area as the first auxiliary line, and determining whether the sum of the angles between all the first auxiliary lines corresponding to the center point is 360° comprises:
determining whether the center point satisfies the following formula:
$${\sum }_{i ∈ P , j = i + 1 ( next )} {sin}^{- 1} ( \frac{\begin{matrix}\to \\ {OP}_{i}\end{matrix} \times \begin{matrix}\to \\ {OP}_{j}\end{matrix}}{\vert \begin{matrix}\to \\ {OP}_{i}\end{matrix} \vert * \vert \begin{matrix}\to \\ {OP}_{j}\end{matrix} \vert} ) = 2 k π ( k ϵ Z )$$
wherein O represents a coordinate of the center point, Pᵢ and Pⱼ represent coordinates of two adjacent vertices in the target snow removal area, a superscripts of \vec{OPᵢ} and \vec{OPⱼ} represent vector symbols, and Z represents a set of integers;
in response to that the center point satisfies the above formula, determining the sum of the angles between all the first auxiliary lines corresponding to the center point is 360°.

5. The smart snow removal method according to claim 3, wherein the taking the connection between each grid vertex of every grid to each vertex of the static obstacle area as the second auxiliary line, and determining whether the sum of the angles between all the second auxiliary lines corresponding to each grid vertex is 360° comprises:
determining whether the grid vertex satisfy the following formula:
$${\sum }_{i ∈ P , j = i + 1 ( next )} {sin}^{- 1} ( \frac{\begin{matrix}\to \\ {DP}_{i}\end{matrix} \times \begin{matrix}\to \\ {DP}_{j}\end{matrix}}{\vert \begin{matrix}\to \\ {DP}_{i}\end{matrix} \vert * \vert \begin{matrix}\to \\ {DP}_{j}\end{matrix} \vert} ) = 2 k π ( k ϵ Z )$$
wherein D represents the coordinates of the grid vertices, Pᵢ and Pⱼ represent the coordinates of two adjacent vertices in the target snow removal area, the superscripts of \vec{DPᵢ} and \vec{DPⱼ} represent vector symbols, and Z represents the set of integers;
in response to that the grid vertex satisfy the above formula, determining the sum of the angles between all the second auxiliary lines corresponding to the grid vertices is 360°.

6. The smart snow removal method according to claim 2, wherein the controlling the snow removal robot to travel on the uncleaned grid with the highest current potential energy value one by one, and performing the snow removal operation on the arrived grid comprises:
in response to the snow removal robot completing the snow removal operation on the snow removal grid, searching, with the snow removal robot as a center, whether there is a first target snow removal grid with the potential energy value being greater than or equal to the potential energy value of the grid where the snow removal robot is currently located within a preset range; wherein the first target snow removal grid is in an uncleared state;
in response to an existence of the first target snow removal grid with the potential energy value being greater than or equal to the potential energy value of the grid where the snow removal robot is currently located within the preset range, controlling the snow removal robot to travel along the snow removal grid to the nearest first target snow removal grid, to perform the snow removal operation on the first target snow removal grid;
in response to an absence of the first target snow removal grid with the potential energy value being greater than or equal to the potential energy value of the grid where the snow removal robot is currently located within the preset range, searching, with the snow removal robot as the center, whether there is a second target snow removal grid with the potential energy value being less than the potential energy value of the grid where the snow removal robot is currently located within the preset range; wherein the second target snow removal grid is in the uncleared state; and
in response to the existence of the second target snow removal grid with the potential energy value being less than the potential energy value of the grid where the snow removal robot is currently located within the preset range, controlling the snow removal robot to travel along the snow removal grid to the nearest second target snow removal grid, to perform the snow removal operation on the second target snow removal grid.

7. The smart snow removal method according to claim 6, wherein after the searching, with the snow removal robot as the center, whether there is the second target snow removal grid with the potential energy value being less than the potential energy value of the grid where the snow removal robot is currently located within the preset range, the method further comprises:
in response to the absence of the second target snow removal grid with potential energy value being less than the potential energy value of the grid where the snow removal robot is currently located within the preset range, searching, with the snow removal robot as the center, whether there is the snow throwing grid within the preset range;
in response to the existence of the snow throwing grid within the preset range, searching whether there is a third target snow removal grid uncleared in the snow removal map;
in response to the existence of the third target snow removal grid in the snow removal map, controlling, through a D*Lite algorithm, the snow removal robot to travel along the snow removal grid to the third target snow removal grid with the highest potential energy value, to perform the snow removal operation on the third target snow removal grid; and
in response to the snow removal robot completing the snow removal operation on the third target snow removal grid, repeating the step of searching, with the snow removal robot as the center, whether there is the first target snow removal grid with potential energy value being greater than or equal to the potential energy value of the grid where the snow removal robot is currently located within the preset range.

8. The smart snow removal method according to claim 6, wherein the performing the snow removal operation on the arrived grid comprises:
collecting snow by the snow feeding component;
determining whether there is the snow throwing grid in the preset range;
in response to the absence of the snow throwing grid in the preset range, taking the uncleared snow removal grid with the potential energy value being the lowest in the preset range as an actual snow throwing grid;
in response to the existence of the snow throwing grid in the preset range, taking the snow throwing grid as the actual snow throwing grid; and
directing a snow throwing direction of the snow throwing component toward the actual snow throwing grid.

9. The smart snow removal method according to claim 6, wherein an uncleaned mark is set on the snow throwing grid and on the snow removal grid where the snow removal robot has not performed the snow removal operation; and
a cleared mark is set on the snow removal grid where the snow removal robot has completed the snow removal operation.

10. The smart snow removal method according to claim 6, wherein the traveling component is provided with a millimeter wave radar sensor device; and
the controlling the snow removal robot to travel along the snow removal grid to the nearest first target snow removal grid, to perform the snow removal operation on the first target snow removal grid comprises:
during the snow removal robot traveling toward the nearest first target snow removal grid, performing, by the millimeter wave radar sensor device, dynamic obstacle detection on a traveling path;
in response to the millimeter wave radar sensor device detecting a dynamic obstacle in front of the snow removal robot, controlling the snow removal robot to stop traveling;
obtaining, by the millimeter wave radar sensor device, dynamic obstacle information, to mark the grid overlapping with the dynamic obstacle as a dynamic obstacle grid; and
excluding the dynamic obstacle grid from the snow removal grid, and repeating the step of searching, with the snow removal robot as the center, whether there is the first target snow removal grid with potential energy value being greater than or equal to the potential energy value of the grid where the snow removal robot is currently located within the preset range.

11. The smart snow removal method according to claim 6, wherein the traveling component is provided with a millimeter wave radar sensor device; and
the controlling the snow removal robot to travel along the snow removal grid to the nearest second target snow removal grid, to perform the snow removal operation on the second target snow removal grid comprises:
during the snow removal robot traveling toward the nearest second target snow removal grid, performing, by the millimeter wave radar sensor device, dynamic obstacle detection on the traveling path;
in response to the millimeter wave radar sensor device detecting the dynamic obstacle in front of the snow removal robot, controlling the snow removal robot to stop traveling;
obtaining, by the millimeter wave radar sensor device, the dynamic obstacle information, to mark the grid overlapping with the dynamic obstacle as the dynamic obstacle grid; and
excluding the dynamic obstacle grid from the snow removal grid, and repeating the step of searching, with the snow removal robot as the center, whether there is the second target snow removal grid with potential energy value being less than the potential energy value of the grid where the snow removal robot is currently located within the preset range.

12. The smart snow removal method according to claim 8, wherein the directing the snow throwing direction of the snow throwing component toward the actual snow throwing grid comprises:
obtaining, through GPS-RTK positioning technology, first relative position information between the grid where the snow removal robot is currently located and the actual snow throwing grid; and
adjusting, according to the first relative position information, a snow throwing angle of the snow throwing component.

13. The smart snow removal method according to claim 12, wherein the snow throwing component comprises a snow throwing drive device, a first rotary drive device, a second rotary drive device, a snow throwing cylinder and a snow throwing cylinder cover;
the snow throwing cylinder is rotatably connected to the traveling component along a vertical axis, and the snow throwing cylinder cover is rotatably connected to the snow throwing cylinder along a horizontal axis;
one end of the snow throwing cylinder is communicated with the snow feeding component, and the other end of the snow throwing cylinder is communicated with one end of the snow throwing cylinder cover;
the snow throwing drive device is provided between one end of the snow throwing cylinder and the snow feeding component; the first rotary drive device is connected to the snow throwing cylinder through a rotary base, and the second rotating drive device is connected to the snow throwing cylinder cover;
the snow throwing drive device is configured to push the snow collected by the snow feeding component into the snow throwing cylinder, and throw the snow out from the other end of the snow throwing cylinder cover; and
the obtaining, through GPS-RTK positioning technology, the first relative position information between the grid where the snow removal robot is currently located and the actual snow throwing grid comprises:
obtaining, through GPS-RTK positioning technology, a first center point coordinates of the grid where the snow removal robot is currently located and a second center point coordinates of the actual snow throwing grid;
taking a horizontal line between the first center point coordinates and the second center point coordinates as an adjustment reference line, and obtaining a length of the adjustment reference line;
driving, by the first rotary drive device, the snow throwing cylinder to rotate, so that a horizontal angle between the direction of the other end of the snow throwing cylinder cover on the horizontal plane and the adjustment reference line is less than a first preset angle; and
calculating a snow throwing inclination angle based on the length of the adjustment reference line, and driving, by the second rotary drive device, the snow throwing cylinder cover to rotate, so that a vertical angle between the direction of the other end of the snow throwing cylinder cover on the vertical plane and the adjustment reference line is equal to the snow throwing inclination angle.

14. The smart snow removal method according to claim 1, wherein the snow feeding component comprises a snow feeding channel, a snow shovel, a snow feeding drive device, a lifting mechanism, an image sensor device and an image processing module;
the snow feeding channel is communicated with the snow throwing component, and the lifting mechanism is connected with the snow feeding channel;
the snow shovel is provided at a snow inlet of the snow feeding channel, and the snow feeding drive device is connected to the snow shovel;
the image sensor device is provided in the snow feeding channel, and the image processing module is electrically connected to the image sensor device and the lifting mechanism; and
the performing the snow removal operation on the arrived grid comprises:
driving, by the snow feeding drive device, the snow shovel to cut external snow, and continuously feeding the external snow into the snow feeding channel;
obtaining, by the image sensor device, a snow feeding image of the snow feeding channel, and transmitting the snow feeding image to the image processing module;
determining, by the image processing module, whether a proportion of the snow in the snow feeding image exceeds a first preset proportion threshold, and whether the proportion of the snow in the snow feeding image is lower than a second preset proportion threshold; wherein the first preset proportion threshold is higher than the second preset proportion threshold;
in response to the proportion exceeding the first preset proportion threshold, driving, by the lifting mechanism, the snow feeding channel to go up; and
in response to the proportion being less than the second preset proportion threshold, driving, by the lifting mechanism, the snow feeding channel to go down.

15. The smart snow removal method according to claim 14, wherein the snow inlet is provided with an infrared sensor device electrically connected to the snow feeding drive device; and
after the driving, by the snow feeding drive device, the snow shovel to cut the external snow, and continuously feeding the external snow into the snow feeding channel, the method further comprises:
obtaining, by the infrared sensor device, a temperature signal at the snow inlet; and
in response to a fluctuation value of the temperature signal exceeding a preset temperature threshold, controlling the snow feeding drive device to stop working.

16. The smart snow removal method according to claim 14, wherein the snow shovel is made of rubber.

17. A snow removal robot, operated by the smart snow removal method according to claim 1, comprising:
a positioning module, configured to obtain the latitude and longitude coordinates of the target snow throwing area and the target snow removal area through GPS-RTK positioning technology to generate the snow removal map;
a rasterization module, configured to rasterize the snow removal map;
a potential field module, configured to assign the potential energy value to the grid located in the target snow removal area in the outward diffusion manner, starting from the grid located in the target snow throwing area, through the BFS algorithm; and
a driver module, configured to control the snow removal robot to travel on the uncleaned grid with the highest current potential energy value one by one, and perform the snow removal operation on the arrived grid.

18. A smart snow removal equipment, comprising:
a controller; and
a memory;
wherein the memory stores at least one instruction or at least one program loaded and executed by the controller to implement the smart snow removal method according to claim 1.
